(19) United States
(12) Patent Application Publication
(10) Pub. No.: US 2004/0189089 A1
(43) Pub. Date: Sep. 30, 2004

(54) Braking device comprising a servomotor and a master cylinder with a simplified assembly

(76) Inventor: Jean-Marc Attard, Chantilly (FR)

Correspondence Address: Leo H McCormick, Bosch Braking Systems, 2112 Mishawaka Avenue, PO Box 4721, South Bend, IN, 46634-4721, US

(21) Appl. No.: 10/484,360

(22) PCT Filed: Jul. 11, 2002
(86) PCT No.: PCT/FR02/02443

(30) Foreign Application Priority Data
Jul. 13, 2001 (FR) 01/09445

(51) Int. Cl. B60T 8/66

(52) U.S. Cl. 303/160

(57) ABSTRACT

This invention relates to a braking device, comprising a master cylinder (1), which is attached to a pneumatic servomotor (2) for an assisted braking, in a tight manner.

The device according to the invention uses a coupling of the so-called “bayonet” type, comprising a cylindrical shaft (21), formed in the casing (20) of the servomotor (1), two inserts (41, 42) restricting the diameter of the opening (210) of the shaft (21), two splines (121), cut in the master cylinder and providing an axial passage for the inserts (41, 42), and two peripheral slots (131, 132) which the inserts (41, 42) engage in the course of a rotational motion of the master cylinder (1) in the shaft (21), and a ring-type seal (3), which is disposed inside the shaft (21) for a reliable tightness between the shaft (21) and the master cylinder (1).

This invention relates generally to braking systems for motor vehicles.

More particularly, the present invention deals with a braking device, which comprises a master cylinder and a pneumatic servomotor for an assisted braking, the master cylinder being attached to a rigid casing of the servomotor in a tight manner.

Such devices are well known in the art and they have been used for decades.

For all that, quite a number of research and development programs have been dealing with such devices all this time, with the aim of improving their performance and/or reducing the manufacturing cost.

The main object of the present invention, in keeping with this trend, is to provide a device of said type, for a quick, easy and reversible assembling process.

To this end, the device according to the invention, which is consistent with the generic definition as per the introductory part hereinabove, is mainly characterised in that the casing of the servomotor comprises a cylindrical shaft, opening into the servomotor through a circular opening having a determined diameter and into which a first end of the master cylinder is introduced by a relative translational motion in a first direction along an axis of revolution of the shaft, in that a ring-type seal is disposed inside the shaft for a reliable tightness between the shaft and a cylindrical outer surface of the master cylinder fitted inside said shaft, in that a plurality of inserts, comprising at least a first and a second inserts fastened inside the casing, restrict locally the diameter of the opening of the shaft, in that the first end of the master cylinder comprises a plurality of splines, cut along the axis of revolution of the shaft and each one of them receiving a corresponding insert belonging to the plurality of inserts, in a selective manner, and in that the first end of the master cylinder has a plurality of peripheral slots, which are angularly offset in relation to the splines and which receive the respective inserts, through a relative rotational motion of the shaft and of the master cylinder about the axis of revolution.

Besides, the subject of the preferred embodiment of the device according to this invention consists in providing an optimum safety against any risk of accidental disassembly.

Therefore, arrangements are made for each peripheral slot to be separated from each adjacent spline by a rotation stop, for an annular groove to interconnect the peripheral slots, for the inserts to be fitted inside the annular groove in the course of a relative free rotational motion of the shaft and of the master cylinder after having introduced the first end of the master cylinder into the shaft by a relative translational motion in a first direction and, once each insert has been positioned in a corresponding slot by means of a relative rotational motion of the shaft and of the master cylinder, for each insert to be rotationally locked between two rotation stops, by means of a relative translational motion of the first end of the master cylinder inside the shaft in a second direction, that is in the opposite direction to the first direction.

The device according to the invention comprises, for instance, two inserts, which are diametrically opposite in relation to the axis of revolution of the shaft.

Besides and preferably, the ring-type seal is fitted in a cavity provided in the outer surface of the master cylinder.

Other features and advantages of the present invention will be apparent from the following detailed description, by way of example and by no means as a limitation, when taken in conjunction with the accompanying drawings, in which :

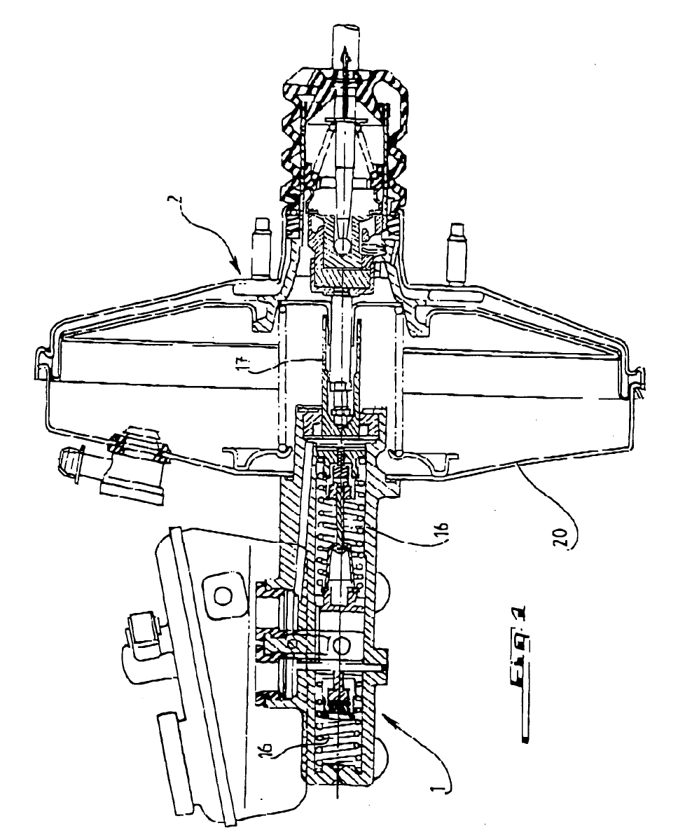

FIG. 1 is a sectional view of a known device ;

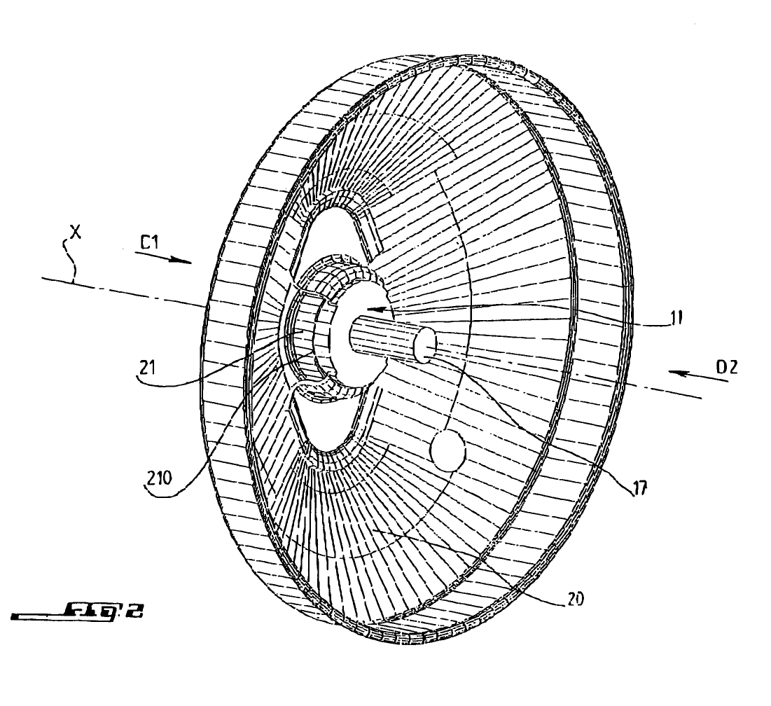

FIG. 2 is a simplified partial perspective view of a device according to this invention, as seen from the inside of the casing of the servomotor ;

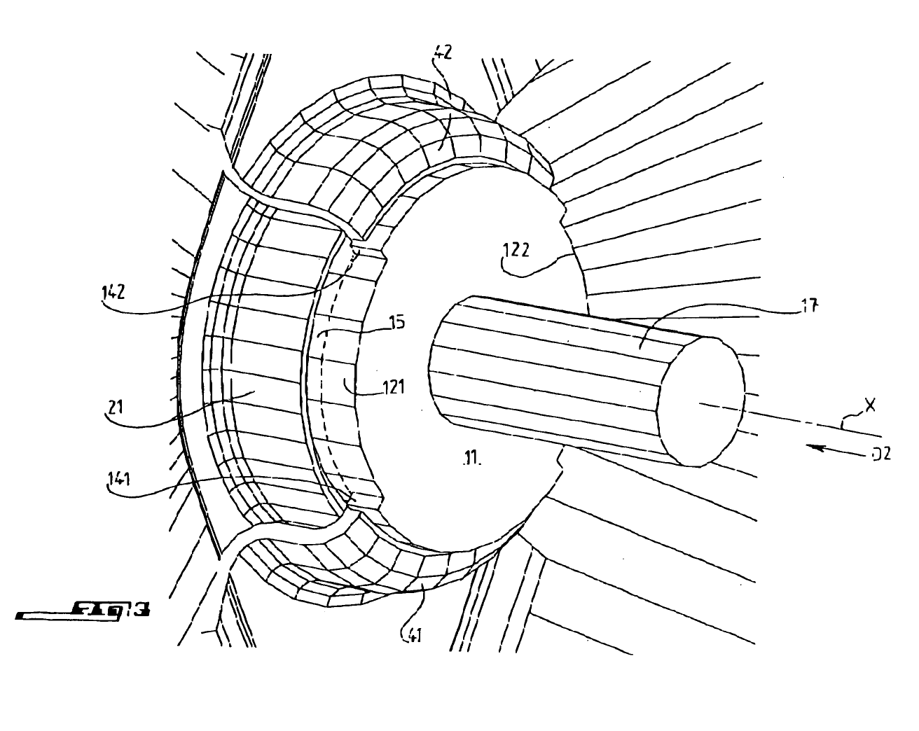

FIG. 3 is a view on a larger scale, showing a part of FIG. 2 ; and

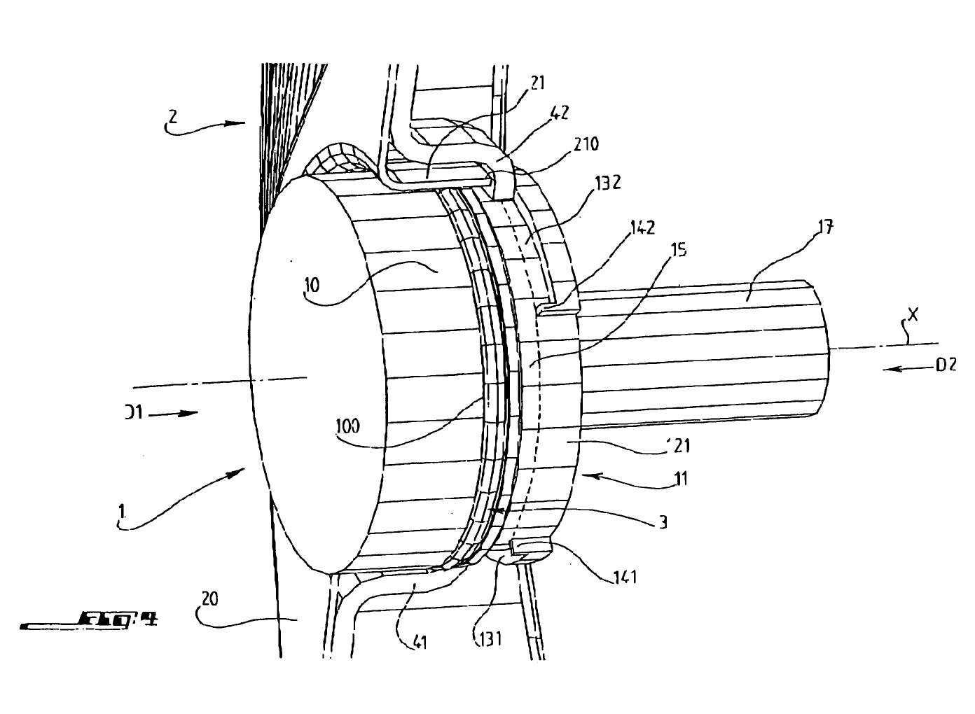

FIG. 4 is a simplified partial perspective view on a larger scale, showing a device according to this invention, as seen from the outside of the casing of the servomotor, a part of such casing being cut away.

As set out hereinbefore, the invention relates to a braking device, which comprises a master cylinder 1 and a pneumatic servomotor 2 for an assisted braking, the master cylinder 1 being attached to the rigid casing 20 of the servomotor in a tight manner.

This invention, dealing more particularly with the attachment of the master cylinder to the servomotor, allows the use of a coupling of the so-called “bayonet” type.

To this end, and first of all, the casing 20 has a cylindrical shaft 21, which opens into the servomotor 2 through a circular opening 210.

The diameter of this opening 210 is dimensioned so as to allow the end 11 of the master cylinder 1 to be fitted into the shaft 21 through the bringing closer together of the master cylinder and of the servomotor, i.e. through a relative translational motion in the direction D1 along the axis of revolution X of the shaft 21.

At a distance from the end 11, the master cylinder 1 exhibits a cylindrical outer surface, fitting into the shaft 21 with a very small clearance.

A ring-type seal 3, e.g. accommodated inside a cavity 100 provided in the outer surface 10 of the master cylinder 1, is disposed inside the shaft 21 for a reliable tightness between the shaft 21 and that cylindrical outer surface 10 of the master cylinder 1.

A plurality of inserts, e.g. two inserts 41 and 42, which are diametrically opposite in relation to the axis of revolution X of the shaft 21, are fastened inside the casing 20 so as to form a local limitation of the diameter of the opening 210 of the shaft 21.

As concerns the end 11 of the master cylinder, it comprises a corresponding number of splines, for instance two splines 121 and 122, cut parallel to the axis of revolution X of the shaft 21 and receiving the inserts 41 and 42 respectively, when the master cylinder and the servomotor are brought closer together.

Besides, the end 11 of the master cylinder 1 has a plurality of peripheral slots, e.g. two slots 131 and 132 which are angularly offset in relation to the splines 121 and 122 and transverse to the latter.

Such slots 131 and 132 are intended to accommodate the inserts 41 and 42, which engage them, respectively, through a relative rotational motion of the shaft 21 and of the master cylinder 1 about the axis of revolution X.

In order to keep the master cylinder in position on the servomotor in an optimal manner after the assembling process, each peripheral slot 131 and 132 is separated from each one of the splines 121 and 122, which is adjacent to it, by a rotation stop, such as 141 and 142, and an annular groove 15 interconnects the peripheral slots 131 and 132, by passing over the stops 141 and 142. Such groove is shown by dotted imaginary lines in FIG. 3 and 4.

The annular groove 15 exhibits a sufficient width for the inserts 41 and 42 to pass between the stops 141 and 142 and the cylindrical surface 10 of the master cylinder 1.

In other words, once the end 11 of the master cylinder 1 has been introduced into the shaft 21, as a result of their being brought closer together in the direction D1, the shaft 21 and the master cylinder 1 may be subjected to a free relative rotational motion through the movement of the inserts 41 and 42 within the annular groove 15.

When the inserts 41 and 42 have been placed in the corresponding slots 131 and 132, thanks to such rotational motion, the master cylinder 1 is moved away from the servomotor 2, in that a translational motion is applied to the end 11 of the master cylinder 1, inside the shaft 21, in the direction D2, that is in the opposite direction to D1, in such a way that each one of the inserts 41 and 42 is rotationally locked between two rotation stops, e.g. 141 and 142.

Now that the master cylinder 1 is attached to the servomotor 2, the inner springs 16 provided in the master cylinder 1 push back the end 11 of the master cylinder away from the actuating rod 17, i.e. they bias such end 11 in the direction D2.

Therefore, the device consisting of the master cylinder and of the servomotor according to this invention affords a very easy assembling process, a very easy disassembling operation and a full safety against any risk of accidental disassembly.

I claim:

1. A braking device, comprising a master cylinder (1) and a pneumatic servomotor (2) for an assisted braking, the master cylinder (1) being attached to a rigid casing (20) of the servomotor in a tight manner, characterised in that the casing (20) of the servomotor comprises a cylindrical shaft (21), opening into the servomotor (2) through a circular opening (210) having a determined diameter and into which a first end (11) of the master cylinder (1) is introduced by a relative translational motion in a first direction (D1) along an axis of revolution (X) of the shaft (21), in that a ring-type seal (3) is disposed inside the shaft (21) for a reliable tightness between the shaft (21) and a cylindrical outer surface (10) of the master cylinder (1) fitted inside said shaft, in that a plurality of inserts (41, 42) comprising at least a first and a second inserts (41, 42) fastened inside the casing (20), restrict locally the diameter of the opening (210) of the shaft (21), in that the first end (11) of the master cylinder comprises a plurality of splines (121, 122), cut along the axis of revolution (X) of the shaft (21) and each one of them receiving a corresponding insert belonging to the plurality of inserts (41, 42), in a selective manner, and in that the first end (11) of the master cylinder (1) has a plurality of peripheral slots (131, 132), which are angularly offset in relation to the splines (121, 122) and which receive the respective inserts (41, 42), through a relative rotational motion of the shaft (21) and of the master cylinder (1) about the axis of revolution (X).

2. The braking device according to claim 1, characterised in that each peripheral slot (131, 132) is separated from each spline (121, 122), which is adjacent to it, by a rotation stop (141, 142), in that an annular groove (15) interconnects the peripheral slots (131, 132), in that the inserts (41, 42) are fitted inside the annular groove (15) in the course of a relative free rotational motion of the shaft (21) and of the master cylinder (1) once the first end (11) of the master cylinder (1) has been introduced into the shaft (21) by a relative translational motion in the first direction (D1) and in that, once each insert (41, 42) has been positioned in a corresponding slot (131, 132) by means of a relative rotational motion of the shaft (21) and of the master cylinder (1), each insert (41, 42) is rotationally locked between two rotation stops (141, 142), by a relative translational motion of the first end (11) of the master cylinder (1) inside the shaft (21) in a second direction (D2), that is in the opposite direction to the first direction (D1).

3. The braking device according to claim 2, characterised in that it comprises two inserts (41, 42), which are diametrically opposite in relation to the axis of revolution (X) of the shaft (21).

4. The braking device according to claim 1, characterised in that the ring-type seal (3) is fitted in a cavity (100) provided in the outer surface (10) of the master cylinder (1).
